(19) United States
(12) Patent Application Publication
(10) Pub. No.: US 2024/0135429 A1
(43) Pub. Date: Apr. 25, 2024

(54) METHOD AND SYSTEM FOR RECOMMENDING ADDRESSES DURING PURCHASE ORDER PROCESSING

(71) Applicant: Dell Products L.P., Round Rock, TX (US)

(72) Inventors: Priya Shanmugasundaram, Bangalore (IN); Saurabh Jha, Austin, TX (US); Sailendu Kumar Patra, Bangalore (IN)

(21) Appl. No.: 17/972,273

(22) Filed: Oct. 23, 2022

(51) Int. Cl. G06Q 30/06; G06Q 30/02

(52) U.S. Cl. CPC G06Q 30/0635; G06Q 30/0211

(57) ABSTRACT

Techniques described herein relate to a method for generating address recommendations. The method includes obtaining, by a recommendation system, an address recommendation request associated with an address, wherein the address is associated with a user; in response to obtaining the address recommendation request: generating a context vector associated with the address; generating an address recommendation based on the context vector using a recommendation model; obtaining user feedback associated with the address recommendation; generating a reward based on the user feedback; and updating the recommendation model based on the context vector, the address recommendation and the reward.

### BACKGROUND

Users may submit purchase orders to obtain goods and services from organizations. Organizations may employ expert users to perform purchase order processing. Computing devices may be used to extract addresses associated with users during purchase order processing. The extracted addresses may be matched with existing addresses during purchase order processing.

### SUMMARY

In general, certain embodiments described herein relate to a method for generating address recommendations. The method may include obtaining, by a recommendation system, an address recommendation request associated with an address, wherein the address is associated with a user; in response to obtaining the address recommendation request: generating a context vector associated with the address; generating an address recommendation based on the context vector using a recommendation model; obtaining user feedback associated with the address recommendation; generating a reward based on the user feedback; and updating the recommendation model based on the context vector, the address recommendation and the reward.

In general, certain embodiments described herein relate to a system for generating address recommendations. The system includes a client and a recommendation system. The recommendation system includes a processor and memory, and is programmed to obtain an address recommendation request associated with an address, wherein the address is associated with a user; in response to obtaining the address recommendation request: generate a context vector associated with the address; generate an address recommendation based on the context vector using a recommendation model; obtain user feedback associated with the address recommendation; generate a reward based on the user feedback; and update the recommendation model based on the context vector, the address recommendation and the reward.

In general, certain embodiments described herein relate to a non-transitory computer readable medium that includes computer readable program code, which when executed by a computer processor enables the computer processor to perform a method for generating address recommendations. The method may include obtaining, by a recommendation system, an address recommendation request associated with an address, wherein the address is associated with a user; in response to obtaining the address recommendation request: generating a context vector associated with the address; generating an address recommendation based on the context vector using a recommendation model; obtaining user feedback associated with the address recommendation; generating a reward based on the user feedback; and updating the recommendation model based on the context vector, the address recommendation and the reward.

Other aspects of the embodiments disclosed herein will be apparent from the following description and the appended claims.

### BRIEF DESCRIPTION OF DRAWINGS

Certain embodiments of the disclosed herein will be described with reference to the accompanying drawings. However, the accompanying drawings illustrate only certain aspects or implementations of the embodiments disclosed herein by way of example and are not meant to limit the scope of the claims.

FIG. 1A shows a diagram of a system in accordance with one or more embodiments disclosed herein.

FIG. 1B shows a diagram of a storage in accordance with one or more embodiments disclosed herein.

FIG. 2 shows a flowchart of a method for performing address recommendation services in accordance with one or more embodiments disclosed herein.

FIG. 3 shows a diagram of the operation of an example system over time in accordance with one or more embodiments disclosed herein.

FIG. 4 shows a diagram of a computing device in accordance with one or more embodiments disclosed herein.

### DETAILED DESCRIPTION

Specific embodiments will now be described with reference to the accompanying figures. In the following description, numerous details are set forth as examples of the embodiments disclosed herein. It will be understood by those skilled in the art that one or more embodiments disclosed herein may be practiced without these specific details and that numerous variations or modifications may be possible without departing from the scope of the embodiments disclosed herein. Certain details known to those of ordinary skill in the art are omitted to avoid obscuring the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as a and a second element labeled as N. This labeling convention means that the data structure may include any number of the elements. A second data structure, also labeled as A to N, may also include any number of elements. The number of elements of the first data structure and the number of elements of the second data structure may be the same or different.

In general embodiments disclosed herein relate to methods, systems, and non-transitory computer readable mediums for recommending addresses during purchase order processing.

In one or more embodiments, organizations may obtain purchase orders from customers specifying products that the customer wishes to purchase and required to complete the purchase such as an address to which to ship the purchased products. In order to complete the purchase, the organization may first need to process the purchase order. The organization may include users (e.g., employees) that manually process purchase orders for the organization. Part of processing a purchase order may include matching an address extracted from the purchase order to an existing address in a customer database to ensure that the address is correct. Some customers may include a large number of addresses, and organizations with a large number of customers may require the user to sift through a substantial amount of addresses to match an extracted address from a purchase order to an existing address included in the customer database. Such a process may require a significant amount of time on the part of the users and may be prone to user errors, negatively impacting the purchase order processing efficiency. Organizations have developed address similarity models to automatically match addresses extracted from purchase orders to existing customer addresses. However, when the similarity is below a certain threshold for a particular address, the users must revert to manually identifying an existing address to match the extracted address, leading to the same problems as discussed above.

To address, at least in part, the aforementioned issues, embodiments disclosed herein relate to a recommendation system that automatically recommends addresses associated with addresses extracted from purchase orders that cannot be directly matched to an existing address. Specifically, embodiments disclosed herein relate to a recommendation system that may: (i) enable clients to submit an address recommendation request associated with the extracted address, (ii) identify potential addresses from a user information repository using selection features associated with the extracted address, (iii) generate a context vector associated with the potential addresses and the user (e.g., customer) associated with the extracted address, (iv) generate an address recommendation using the context vector, the potential addresses, and a recommendation model, (v) obtain user feedback that is used to generate a reward associated with the address recommendation system, and (vi) update the recommendation model based on the reward, context vector, and the address recommendation using a multi-arm bandit upper confidence interval reinforcement learning algorithm. Consequently, address recommendations may automatically be provided to users performing purchase order processing, minimizing the amount of time required to process purchase order and improving purchase order processing efficiency. Moreover, the recommendation system iteratively updates the recommendation model address recommendation selection based on user feedback, improving the accuracy of the address recommendations generated by the recommendation system.

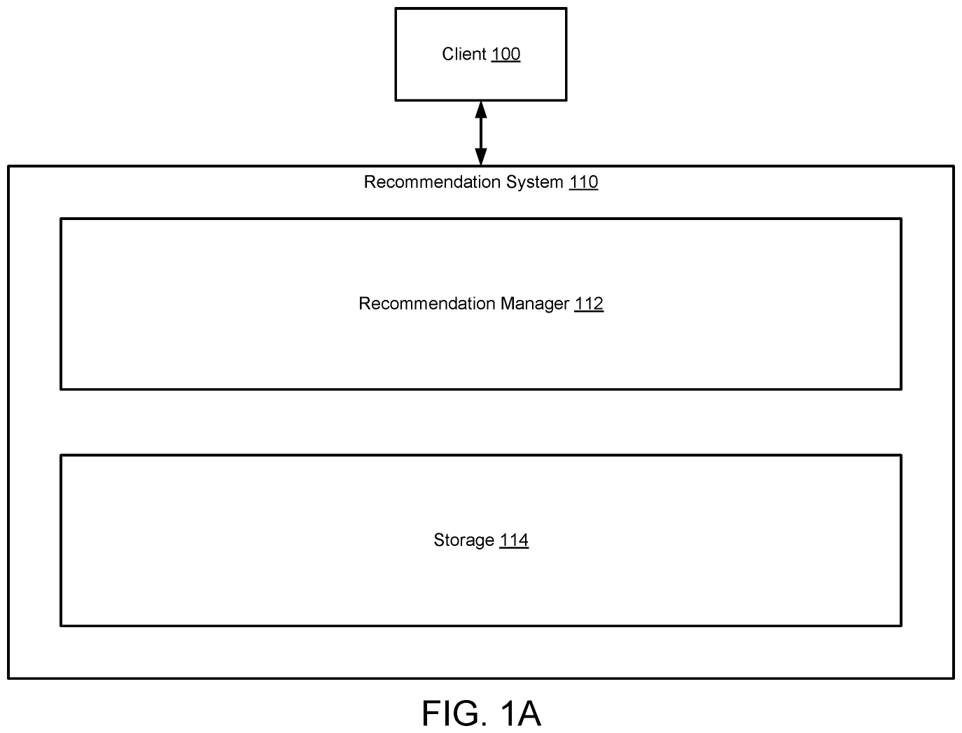

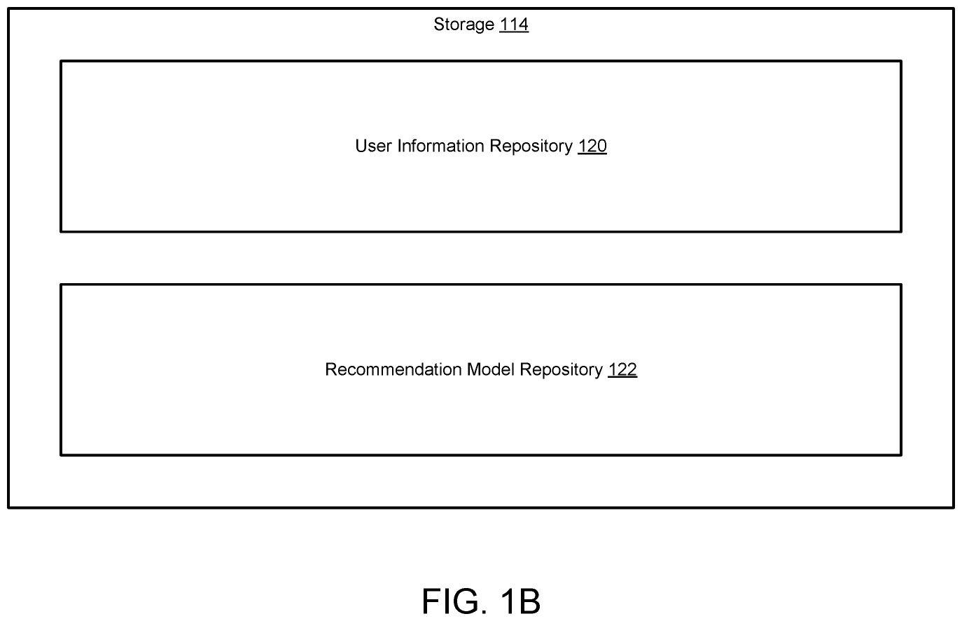

FIG. 1A shows a diagram a system in accordance with one or more embodiments disclosed herein. The system may include a client (100) and a recommendation system (110). The client (100) may provide recommendation requests and information associated with users to the recommendation system (110), which in turn provides address recommendation services to the client (100). The components of the system illustrated in FIG. 1A may be operatively connected to each other and/or operatively connected to other entities (not shown) via any combination of wired (e.g., Ethernet) and/or wireless networks (e.g., local area network, wide area network, Internet, etc.) without departing from embodiments disclosed herein. Each component of the system illustrated in FIG. 1A is discussed below.

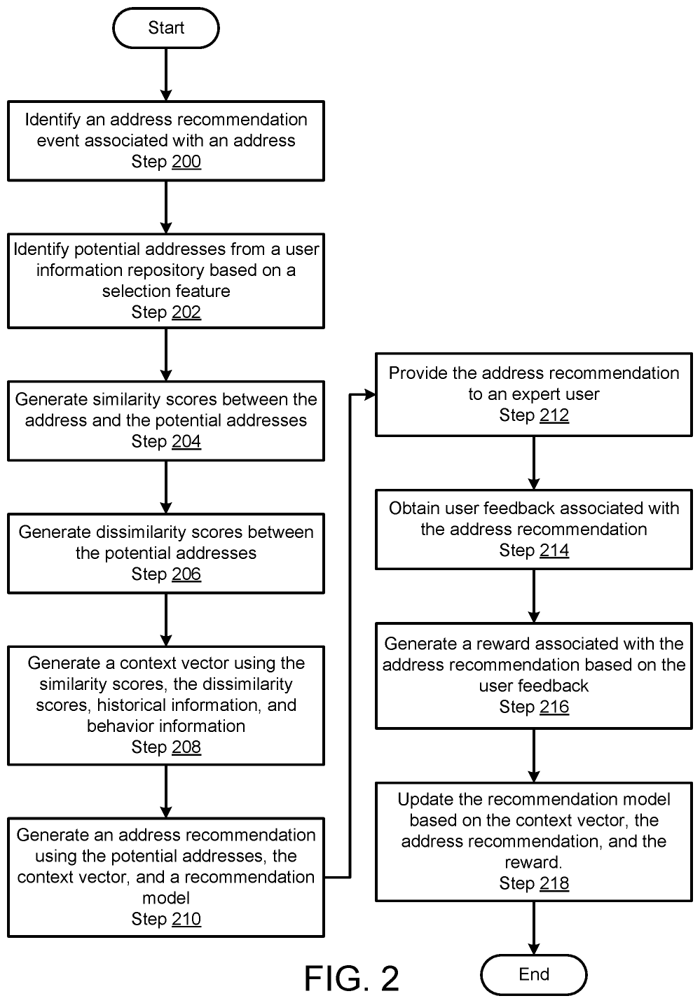

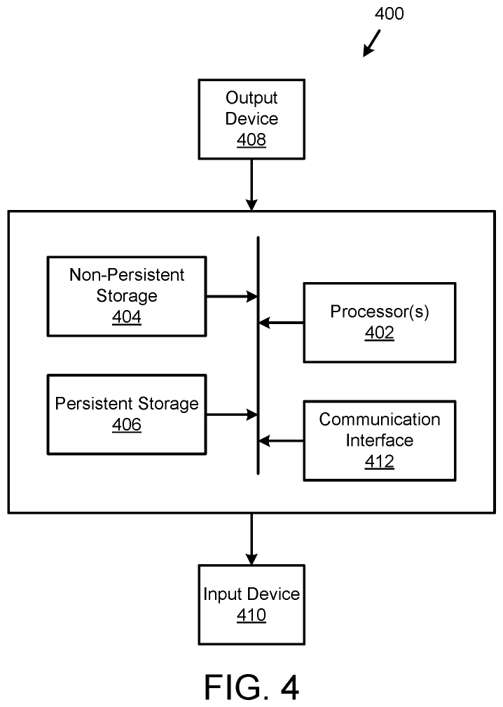

In one or more embodiments, the client (100) may be implemented using one or more computing devices. A computing device may be, for example, mobile phones, tablet computers, laptop computers, desktop computers, servers, or cloud resources. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described herein and/or all, or a portion, of the methods illustrated in FIG. 2. The client (100) may be implemented using other types of computing devices without departing from embodiments disclosed herein. For additional details regarding computing devices, refer to FIG. 4.

In one or more embodiments, the client (100) may be implemented using logical devices without departing from embodiments disclosed herein. For example, the client (100) may include virtual machines that utilize computing resources of any number of physical computing devices to provide the functionality of the client (100). The client (100) may be implemented using other types of logical devices without departing from the embodiments disclosed herein.

In one or more embodiments, the client (100) may include the functionality to, or may be otherwise programmed or configured to, obtain address recommendation services from the recommendation system (110). As part of obtaining recommendation services, the client (100), or users thereof, may provide information associated with users that the recommendation system (110) may use to generate address recommendations. The client (100) may further provide recommendation requests and extracted addresses from purchase orders associated with recommendation requests to the recommendation system (110). The client (100) may include the functionality to perform all, or a portion of, the methods of FIG. 2. The client (100) may include other and/or additional functionalities without departing from embodiments disclosed herein.

In one or more embodiments, the recommendation system (110) may be implemented using one or more computing devices. A computing device may be, for example, a mobile phone, tablet computer, laptop computer, desktop computer, server, distributed computing system, or a cloud resource. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions of the recommendation system (110) described herein and/or all, or a portion, of the methods illustrated in FIG. 2. The recommendation system (110) may be implemented using other types of computing devices without departing from the embodiments disclosed herein. For additional details regarding computing devices, refer to FIG. 4.

The recommendation system (110) may be implemented using logical devices without departing from the embodiments disclosed herein. For example, the recommendation system (110) may include virtual machines that utilize computing resources of any number of physical computing devices to provide the functionality of the recommendation system (110). The recommendation system (110) may be implemented using other types of logical devices without departing from the embodiments disclosed herein.

In one or more embodiments, the recommendation system (110) may include the functionality to, or otherwise be programmed or configured to, perform address recommendation services for the client (100). The recommendation system (110) may include the functionality to perform all, or a portion of, the methods discussed in FIG. 2. The recommendation system (110) may include other and/or additional functionalities without departing from embodiments disclosed herein. For additional information regarding the functionality of the recommendation system (110), refer to FIG. 2.

To perform the aforementioned functionality of the recommendation system (110), the recommendation system (110) may include a recommendation manager (112) and storage (114). The recommendation system (110) may include other, additional, and/or fewer components without departing from embodiments disclosed herein. Each of the aforementioned components of the recommendation system (110) is discussed below.

In one or more embodiments disclosed herein, the recommendation manager (112) is implemented as a physical device. The physical device may include circuitry. The physical device may be, for example, a field-programmable gate array, application specific integrated circuit, programmable processor, microcontroller, digital signal processor, or other hardware processor. The physical device may be configured to provide the functionality of the recommendation manager (112) described throughout this Detailed Description.

In one or more embodiments disclosed herein, the recommendation manager (112) is implemented as computer instructions, e.g., computer code, stored on a storage (e.g., storage (114)) that when executed by a processor of the recommendation system (110) causes the recommendation system (110) to provide the functionality of the recommendation manager (112) described throughout this Detailed Description.

In one or more embodiments, the recommendation manager (112) includes the functionality to, or is otherwise configured to, perform the address recommendation services of the recommendation system (110). The address recommendation services performed by the recommendation manager (112) may include generating context vectors associated with recommendation requests, identifying potential addresses, generating an address recommendation, obtaining user feedback, generating a reward, and updating a recommendation model based on the reward. The recommendation manager (112) may include the functionality to perform all, or a portion thereof, the steps in the methods depicted in FIG. 2. The recommendation manager (112) may include, or be configured to perform, other and/or additional functionalities without departing from embodiments disclosed herein. For additional information regarding the functionality of the recommendation manager (112), refer to FIG. 2.

In one or more embodiments, the storage (114) may be implemented using one or more volatile or non-volatile storages or any combination thereof. The storage (114) may include the functionality to, or otherwise be configured to, store and provide information that may be used by the recommendation system (110) and the components thereof (e.g., 112) to perform address recommendation services. The storage (114) may include, or otherwise be configured to include, other and/or additional functionalities without departing from embodiments disclosed herein. For additional information regarding the storage (114), refer to FIG. 1B.

Although the system of FIG. 1A is shown as having a certain number of components (e.g., 100, 110, 112, 114), in other embodiments disclosed herein, the system may have more or fewer components. For example, the functionality of each component described above may be split across components or combined into a single component. Further still, each component may be utilized multiple times to carry out an iterative learning operation.

FIG. 1B shows a diagram of a storage in accordance with one or more embodiments disclosed herein. The storage (114) may be an embodiment of the storage (114, FIG. 1A) discussed above. As discussed above, may include the functionality to, or otherwise be configured to, store and provide information that may be used by the recommendation system (110) and the components thereof (e.g., 112) to perform address recommendation services. The storage may include a user information repository (120) and a recommendation model repository (122). Each of these aforementioned data structures is further discussed below.

In one or more embodiments, the user information repository (120) may be one or more data structures that include user information associated with users of the client (100). In one or more embodiments, the user information included in the user information repository may be generated and updated by the client (100) and periodically sent to the recommendation system (110). The use information may include entries associated with customers that have previously submitted a purchase order to the client. An entry may include a customer identifier associated with a customer, addresses associated with the customer, historical information associated with the customer, and behavior information associated with the customer. The entry may include other and/or additional information associated with customers without departing from embodiments disclosed herein.

In one or more embodiments, the historical information may include the quantity of past address errors associated with the customer, the address fields that were incorrect in the address errors, and a priorities associated with the past address errors. The priorities may include values between one and three indicating the severity of the address errors, with the higher the priority, the more severe the address error. The historical information may indicate to the recommendation manager (112) an exploration capacity for address recommendations associated with the user. If the user is associated with a lot address error and/or high priority address errors, the recommendation manager (112) may be less likely to explore address recommendations.

In one or more embodiments, the behavior information may specify the behavior of a customer following an address error. The behavior information may include the days since the last customer purchase order associated with the user was submitted, the average order value associated with the customer, and the number of visits to the client (100) (e.g., either in person or online). The behavior information may include other and/or additional information without departing from embodiments disclosed herein. The behavior information may specify how address errors impact the behavior of the customer.

In one or more embodiments, the recommendation model repository (122) may be one or more data structures that include the recommendation model (e.g., computer instructions, which when executed by a processor of the recommendation system (110) cause the recommendation system (110) to provide the functionality of the recommendation model) and previous address recommendations learning sets. The address recommendation learning sets may include address recommendations, context vectors, and rewards which may be used to update the recommendation model. The recommendation model repository (122) may be maintained (e.g., updated) by the recommendation manager (112). The recommendation model repository (122) may include other and/or additional information associated with the recommendation model and/or previously generated address recommendations without departing from embodiments disclosed herein.

While the data structures (e.g., 120, 122) are illustrated as separate data structures and have been discussed as including a limited amount of specific information, any of the aforementioned data structures may be divided into any number of data structures, combined with any number of other data structures, and may include additional, less, and/or different information without departing from embodiments disclosed herein. Additionally, while illustrated as being stored in the storage (114), any of the aforementioned data structures may be stored in different locations (e.g., in storage of other computing devices such as the client (100)) and/or spanned across any number of computing devices without departing from embodiments disclosed herein. The data structures of the storage (114) may be implemented using, for example, lists, linked lists, tables, unstructured data, databases, etc.

FIG. 2 shows a flowchart of a method for performing address recommendation services in accordance with one or more embodiments disclosed herein. The method of FIG. 2 may be performed by, for example, the recommendation system (e.g., 110, FIG. 1A). Other components of the system illustrated in FIG. 1A may perform all, or a portion, of the method of FIG. 2 without departing from the scope of the embodiments disclosed herein.

While FIG. 2 is illustrated as a series of steps, any of the steps may be omitted, performed in a different order, additional steps may be included, and/or any or all of the steps may be performed in a parallel and/or partially overlapping manner without departing from the scope of the embodiments described herein.

Turning to FIG. 2, in Step 200, an address recommendation request associated with an address is obtained. In one or more embodiments, the client may perform address extraction for a purchase order and attempt to match the extracted address with addresses stored in a user address database. If the client cannot find a match that is above a configurable match threshold (e.g., performing basic similarity comparisons and/or other comparisons), the client may send an address recommendation request to the address recommendation system. The address recommendation request may include the address extracted from the purchase order. The address recommendation request may further include one or more address selection features. The address selection features may include a postal code of the extracted address and the customer identifier associated with the extracted address. The address recommendation request may include other and/or additional information associated with the extracted address without departing from embodiments disclosed herein.

The address recommendation request may be sent to the recommendation system using any appropriate method of data transmission without departing from embodiments disclosed herein. For example, the address recommendation request may be sent as part of a message including multiple network packets through one or more network devices that operatively connect the client to the recommendation system. The address recommendation request associated with the address may be obtained from the client via other and/or additional methods without departing from embodiments disclosed herein.

In Step 202, potential addresses are identified from a user information repository based on a selection feature. As discussed above, the user information repository may include all addresses associated with all users that have submitted purchase orders to the client. In one or more embodiments, the recommendation manager of the recommendation system uses the selection features in the address recommendation request to identify a portion of the addresses included in the user information repository associated with the extracted address as potential addresses. The recommendation manager may identify addresses included in the user information repository that are associated with the customer identifier included in the address recommendation request and/or that include the postal code included in the address recommendation system. The potential addresses may be identified from a user information repository based on a selection feature via other and/or additional methods without departing from embodiments disclosed herein.

In Step 204, similarity scores are generated between the address and the potential addresses. In one or more embodiments, the recommendation manager of the recommendation system generates a similarity score between the address associated with the address recommendation request (e.g., the address extracted from the purchase order) and each address included in the potential addresses identified in Step 202 above. The recommendation manager may use any appropriate method for generating similarity scores without departing from embodiments disclosed herein. For example, the recommendation manager may use a Jaro-Winkler algorithm, a Levenshtein distance algorithm, and/or an exact match principle algorithm for different address fields (e.g., customer identifier, house number, street name, city, country, etc.) to generate similarity scores between the address and each potential address. A similarity score may be represented as a vector that includes the similarity of each address field (e.g., customer identifier, house number, street name, city, country, etc.) between the address and a potential address. A similarity scores may specify how similar the address is to a potential address. Similarity scores may be generated between the address and the potential addresses via other and/or additional methods without departing from embodiments disclosed herein.

In Step 206, dissimilarity scores are generated between the potential addresses. In one or more embodiments, the recommendation manager of the recommendation system generates a dissimilarity score between potential addresses. For each potential address, a dissimilarity score may be generated between each other potential address. The recommendation manager may use any appropriate method for generating dissimilarity scores without departing from embodiments disclosed herein. For example, the recommendation manager may use a Jaro-Winkler algorithm, a Levenshtein distance algorithm, and/or an exact match principle algorithm for different address fields (e.g., customer identifier, house number, street name, city, country, etc.) to generate dissimilarity scores between the potential addresses. A dissimilarity score may be represented as a vector that includes the dissimilarity of each address field (e.g., customer identifier, house number, street name, city, country, etc.) between one potential address and another potential address. A dissimilarity scores may specify how dissimilar the one potential address is compared to another potential address. Potential addresses that are too similar (e.g., include “rd.” instead of “road”) may be duplicative and the recommendation manager may ignore such duplicative addresses during the selection of address recommendations based on the dissimilarity scores. Dissimilarity scores may be generated between the potential addresses via other and/or additional methods without departing from embodiments disclosed herein.

In Step 208, a context vector is generated using the similarity scores, the dissimilarity scores, historical information, and behavior information. As discussed above, the user information repository may include user entries associated with customers of the client. The recommendation manager of the recommendation system may obtain historical information and behavior information from the user entry associated with the customer identifier included in the address recommendation request. The recommendation manager then generates a context vector by including the historical information and behavior information with the similarity scores and the dissimilarity scores. As a result, the context vector may include two different types of parameters: (i) action parameters associated with actions (also referred to as arms) the recommendation manager may select and (ii) user parameters associated with the historical information and behavior information of the customer associated with the purchase order. By including both action parameters and user parameters in the context vector, action selection optimization may be improved. The context vector may be generated using the similarity scores, the dissimilarity scores, the historical information, and the behavior information via other and/or additional methods without departing from embodiments disclosed herein.

In Step 210, an address recommendation is generated using the potential addresses, the context vector, and an address recommendation model. In one or more embodiments, the recommendation manager of the recommendation system may generate an address recommendation by applying a recommendation model tot eh context vector and the potential addresses. The address recommendation may be a potential address of the potential addresses selected by the recommendation model. The recommendation model may be a machine learning model (e.g., a neural network) which implements an upper confidence bound multi-armed bandit algorithm. The recommendation model selects an action (also referred to as an arm) based on the context vector and the current payoff function implemented by the recommendation model. The payoff function may specify the expected reward and upper confidence interval associated with a particular action based on the context vector. The recommendation model may balance exploitation and exploration, specified by the expected reward and the upper confidence interval of the payoff function respectively. The recommendation model may select the action that includes the highest combination of expected reward and upper confidence interval. Over time, as the payoff function becomes more optimized, the upper confidence interval decreases, causing the recommendation model to exploit the expected reward by selecting actions associated with the highest expected reward. The address recommendation may be generated using the potential addresses, the context vector, and an address recommendation model via other and/or additional methods without departing from embodiments disclosed herein.

In Step 212, the address recommendation is provided to an expert user. In one or more embodiments, the recommendation manager provides the address recommendation to the expert user. The expert user may perform purchase order processing. The recommendation manager may provide the address recommendation to the expert user using any appropriate method of conveying information to a user without departing from embodiments disclosed herein. For example, the recommendation manager may provide the address recommendation to the expert user through a user interface (e.g., a graphical user interface) that may display the address recommendation to the expert user. The address recommendation may be provided to the expert user via other and/or additional methods without departing from embodiments disclosed herein.

In Step 214, user feedback associated with the address recommendation is obtained. In one or more embodiments, the expert user may manually compare the address recommendation with the address extracted from the purchase order. The expert user may confirm that the address recommendation matches the extracted address and proceed to process the purchase order using the address recommendation. Alternatively, the expert user may determine that the address recommendation does not match the extracted address and manually searches the user information repository for a matching address. The expert user may indicate such determination through user feedback and provide the user feedback to the recommendation engine. The expert user may provide the user feedback to the recommendation engine using any appropriate method for submitting information without departing from embodiments disclosed herein. For example, the expert user may provide the user feedback through a user interface (e.g., a graphical user interface) by clicking one or more buttons or entering one or more messages that indicates whether the expert user used the address recommendation. The user feedback associated with the address recommendation may be obtained via other and/or additional methods without departing from embodiments disclosed herein.

In Step 216, a reward associated with the address recommendation is generated. In one or more embodiments, recommendation manager of the recommendation system may generate the reward using the reward function and the user feedback. As discussed above, the user feedback may specify whether the expert user used the address recommendation to complete the purchase order processing. The reward function may specify that if the expert user used the address recommendation, then generate a reward with a value of one. The reward function may further specify that if the expert user did not use the address recommendation, then generate a reward with a value of zero. The reward associated with the address recommendation may be generated via other and/or additional methods without departing from embodiments disclosed herein.

In Step 218, the recommendation model is updated based on the context vector, the address recommendation, and the reward. In one or more embodiments, the recommendation manager may update the recommendation model parameters (e.g., neural network weights) to generate a new payoff function based on the context vector, the address recommendation, and the reward. The recommendation model may be updated based on the context vector, the address recommendation, and the reward via other and/or additional methods without departing from embodiments disclosed herein.

In one or more embodiments disclosed herein, the method ends following Step 218.

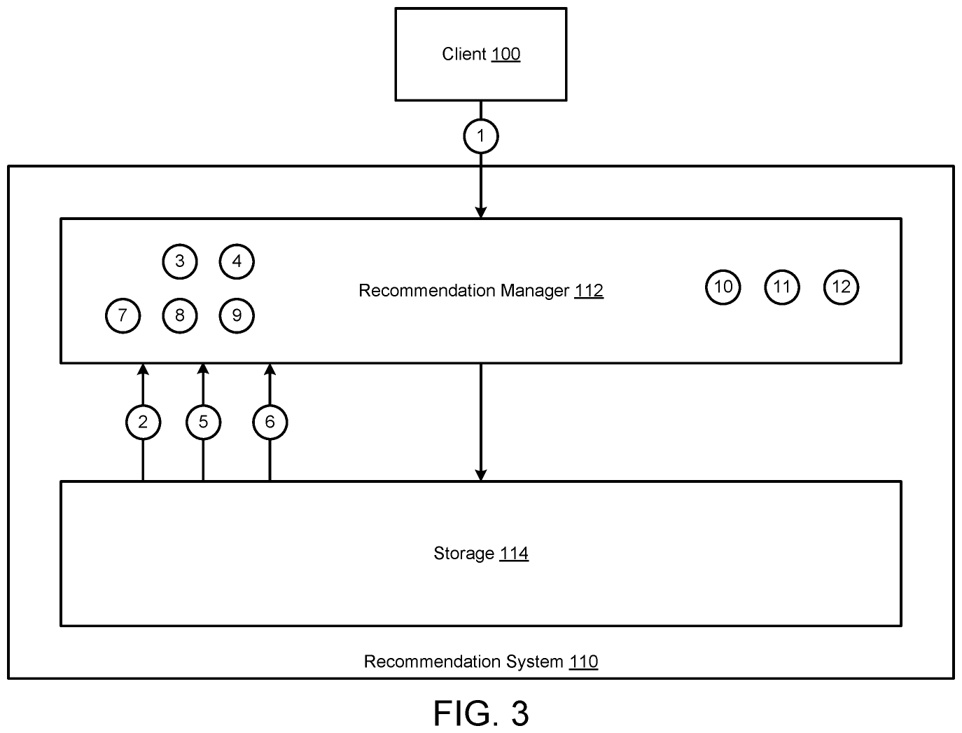

To further clarify embodiments disclosed herein, a non-limiting example is provided in FIG. 3. FIG. 3 shows a diagram of the operation of an example system over time in accordance with one or more embodiments disclosed herein. FIG. 3 show an example system similar to that illustrated in FIG. 1A. Actions performed by components of the illustrated system are illustrated by numbered, circular boxes interconnected, in part, using arrowed lines. For the sake of brevity, only a limited number of components of the system of FIG. 1A are illustrated in FIG. 3.

### Example

Consider a scenario as illustrated in FIG. 3 in which a client (100), at Step 1, sends an address recommendation request to a recommendation system (110). The address recommendation request includes an address extracted from a purchase order. At Step 2, the recommendation manager (112) of the recommendation system (110) identifies potential addresses from a user information repository stored in the storage (114) based on the customer identifier and the postal code of the address associated with the address recommendation request. The potential addresses include five different addresses associated with the customer identifier and the postal code of the extracted address. After that, at Step 3, the recommendation manager (112) generates similarity scores between the extracted address and the five potential addresses. Then, at Step 4, the recommendation manager (112) generates dissimilarity scores between the five potential addresses.

Then, at Step 5, the recommendation manager (112) obtains historical information associated with the user corresponding to the customer identifier from the user information repository stored in the storage (114). Then, at Step 6, the recommendation manager (112) obtains behavior information associated with the user corresponding to the customer identifier from the user information repository stored in the storage (114). After generating the similarity scores and the dissimilarity scores and obtaining the historical information and behavior information, at Step 7, the recommendation manager (112) generates a context vector using the similarity scores, the dissimilarity scores, the historical information, and the behavior information.

Following the generation of the context vector, at Step 8, the recommendation manager (112) generates an address recommendation using the potential addresses, the context vector, and an address recommendation model. The address recommendation is one of the five potential addresses. At Step 9, the recommendation manager (112) provides the address recommendation to an expert user through a graphical user interface. Then, at Step 10, the expert user confirms that the address recommendation matches the extracted address and provides user feedback to the recommendation manager (112) by checking a box on the graphical user interface that indicates that the expert user used the address recommendation to process the purchase order. Then, at Step 11, the recommendation manager (112) generates a reward associated with the address recommendation using the user feedback and the reward function. Because the user feedback indicates that the expert user used the address recommendation to process the purchase order, the recommendation manager (112) generates a reward with the value of one based on the reward function. Finally, at Step 12, the recommendation manager (112) updates the recommendation model based on the context vector, the address recommendation, and the reward.

### End of Example

Thus, as illustrated in FIG. 3, embodiments disclosed herein may provide a system that enables a recommendation manager to select address recommendations based on context vectors for purchase order processing. The recommendation manager may use a recommendation model that iteratively improves the address recommendation selection using address recommendations, context vectors, and rewards.

As discussed above, embodiments disclosed herein may be implemented using computing devices. FIG. 4 shows a diagram of a computing device in accordance with one or more embodiments disclosed herein. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment disclosed herein, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

As used herein, an entity that is programmed to or configured to perform a function (e.g., step, action, etc.) refers to one or more hardware devices (e.g., processors, digital signal processors, field programmable gate arrays, application specific integrated circuits, etc.) that provide the function. The hardware devices may be programmed to do so by, for example, being able to execute computer instructions (e.g., computer code) that cause the hardware devices to provide the function. In another example, the hardware device may be programmed to do so by having circuitry that has been adapted (e.g., modified) to perform the function. An entity that is programmed to perform a function does not include computer instructions in isolation from any hardware devices. Computer instructions may be used to program a hardware device that, when programmed, provides the function.

The problems discussed above should be understood as being examples of problems solved by embodiments disclosed herein and the embodiments disclosed herein should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments disclosed herein have been described above with respect to a limited number of embodiments, those skilled in the art, having the benefit of this disclosure, will appreciate that other embodiments can be devised which do not depart from the scope of the embodiments disclosed herein as of the embodiments disclosed herein. Accordingly, the scope of the embodiments disclosed herein should be limited only by the attached claims.

What is claimed is:

1. A method for generating address recommendation, comprising:
obtaining, by a recommendation system, an address recommendation request associated with an address, wherein the address is associated with a user;
in response to obtaining the address recommendation request:
generating a context vector associated with the address;
generating an address recommendation based on the context vector using a recommendation model;
obtaining user feedback associated with the address recommendation;
generating a reward based on the user feedback; and
updating the recommendation model based on the context vector, the address recommendation and the reward.

2. The method of claim 1, wherein the address is extracted from a purchase order.

3. The method of claim 2, wherein the user feedback specifies whether an expert user used the address recommendation to process the purchase order.

4. The method of claim 3, wherein generating the reward based on the user feedback comprises:
generating a first reward if the expert user used the address recommendation to process the purchase order; or
generating a second reward if the expert user did not use the address recommendation to process the purchase order.

5. The method of claim 1, wherein generating the context vector associated with the address comprises:
identifying a plurality of potential addresses using a selection feature;
generating similarity scores between the address and each of the potential address;
generating dissimilarity scores between each of the potential addresses;
obtaining historical information associated with the user from a user information repository; and
obtaining behavior information associated with the user from the user information repository.

6. The method of claim 5, wherein the context vector comprises:
the similarity scores;
the dissimilarity scores;
the historical information; and
the behavior information.

7. The method of claim 5, wherein the address recommendation comprises a potential address of the potential addresses.

8. A non-transitory computer readable medium comprising computer readable program code, which when executed by a computer processor enables the computer processor to perform a method for generating address recommendations, the method comprising:
obtaining, by a recommendation system, an address recommendation request associated with an address, wherein the address is associated with a user;
in response to obtaining the address recommendation request:
generating a context vector associated with the address;
generating an address recommendation based on the context vector using a recommendation model;
obtaining user feedback associated with the address recommendation;
generating a reward based on the user feedback; and
updating the recommendation model based on the context vector, the address recommendation and the reward.

9. The non-transitory computer readable medium of claim 8, wherein the address is extracted from a purchase order.

10. The non-transitory computer readable medium of claim 9, wherein the user feedback specifies whether an expert user used the address recommendation to process the purchase order.

11. The non-transitory computer readable medium of claim 10, wherein generating the reward based on the user feedback comprises:
generating a first reward if the expert user used the address recommendation to process the purchase order; or
generating a second reward if the expert user did not use the address recommendation to process the purchase order.

12. The non-transitory computer readable medium of claim 8, wherein generating the context vector associated with the address comprises:
identifying a plurality of potential addresses using a selection feature;
generating similarity scores between the address and each of the potential address;
generating dissimilarity scores between each of the potential addresses;
obtaining historical information associated with the user from a user information repository; and
obtaining behavior information associated with the user from the user information repository.

13. The non-transitory computer readable medium of claim 12, wherein the context vector comprises:
the similarity scores;
the dissimilarity scores;
the historical information; and
the behavior information.

14. The non-transitory computer readable medium of claim 8, wherein the address recommendation comprises a potential address of the potential addresses.

15. A system for generating address recommendations, comprising:
a client; and
a recommendation manager, comprising a processor and memory, programmed to:
obtain an address recommendation request associated with an address, wherein the address is associated with a user;
in response to obtaining the address recommendation request:
generate a context vector associated with the address;
generate an address recommendation based on the context vector using a recommendation model;
obtain user feedback associated with the address recommendation;
generate a reward based on the user feedback; and
update the recommendation model based on the context vector, the address recommendation and the reward.

16. The system of claim 15, wherein the address is extracted from a purchase order.

17. The system of claim 16, wherein the user feedback specifies whether an expert user used the address recommendation to process the purchase order.

18. The system of claim 17, wherein generating the reward based on the user feedback comprises:
generating a first reward if the expert user used the address recommendation to process the purchase order; or
generating a second reward if the expert user did not use the address recommendation to process the purchase order.

19. The system of claim 15, wherein generating the context vector associated with the address comprises:
identifying a plurality of potential addresses using a selection feature;
generating similarity scores between the address and each of the potential address;
generating dissimilarity scores between each of the potential addresses;
obtaining historical information associated with the user from a user information repository; and
obtaining behavior information associated with the user from the user information repository.

20. The system of claim 19, wherein the context vector comprises:
the similarity scores;
the dissimilarity scores;
the historical information; and
the behavior information.
